(19) United States
(12) Patent Application Publication
(10) Pub. No.: US 2026/0196602 A1
(43) Pub. Date: Jul. 9, 2026

(54) TRACTION BATTERY PACKS WITH SCALABLE IMMERSION COOLED BATTERY SYSTEMS

(71) Applicant: FORD GLOBAL TECHNOLOGIES, LLC, Dearborn, MI (US)

(72) Inventors: Sangyeon KIM, Northville, MI (US); Timothy R. GERNANT, Ann Arbor, MI (US); Pradeep ELUMALAI, Northville, MI (US)

(21) Appl. No.: 19/009,200

(22) Filed: Jan. 3, 2025

(51) Int. Cl. H01M 10/6567; B60L 50/64; B60L 58/26; H01M 10/613; H01M 10/625; H01M 10/643; H01M 10/658; H01M 50/213; H01M 50/262; H01M 50/271; H01M 50/291; H01M 50/507; H01M 50/516

(52) U.S. Cl. CPC H01M 10/6567; B60L 50/64; B60L 58/26; H01M 10/613; H01M 10/625; H01M 10/643; H01M 10/658; H01M 50/213; H01M 50/262; H01M 50/271; H01M 50/291; H01M 50/507; H01M 50/516; H01M 2220/20

(57) ABSTRACT

Traction battery packs are provided with immersion cooled battery systems. An exemplary traction battery pack battery system may include a battery module that includes a top frame, a bottom frame, and a plurality of cylindrical battery cells. The battery system may be configured to establish an immersion thermal management system that includes various cooling channels for directing an immersion coolant over and around the plurality of cylindrical battery cells.

### TECHNICAL FIELD

This disclosure relates generally to electrified vehicle traction battery packs, and more particularly to traction battery packs that include immersion cooled battery systems.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery system according to an exemplary aspect of the present disclosure includes, among other things, a bottom frame, a top frame securable to the bottom frame and including a compartment, and a cylindrical battery cell received within the compartment. The top frame is configured such that a first cooling channel extends between the cylindrical battery cell and an internal wall that establishes at least a portion of the compartment.

In a further non-limiting embodiment of the foregoing battery system, the compartment is hexagonal shaped.

In a further non-limiting embodiment of either of the foregoing battery systems, the top frame includes a honeycomb-like structure that provides the compartment.

In a further non-limiting embodiment of any of the foregoing battery systems, an upper portion of the top frame includes a first standoff and a second standoff.

In a further non-limiting embodiment of any of the foregoing battery systems, a second cooling channel extends between the first standoff and the second standoff.

In a further non-limiting embodiment of any of the foregoing battery systems, the second cooling channel is fluidly connected to the first cooling channel.

In a further non-limiting embodiment of any of the foregoing battery systems, the bottom frame includes a pocket sized to receive the cylindrical battery cell.

In a further non-limiting embodiment of any of the foregoing battery systems, the pocket is established by a set of tabs that protrude upwardly from a floor of the bottom frame.

In a further non-limiting embodiment of any of the foregoing battery systems, a second cooling channel extends between a first tab and a second tab of he set of tabs.

In a further non-limiting embodiment of any of the foregoing battery systems, the second cooling channel is fluidly connected to the first cooling channel.

In a further non-limiting embodiment of any of the foregoing battery systems, the bottom frame includes one of a flexible clip or a clip structure, and the top frame includes the other of the flexible clip or the clip structure. The flexible clip is engageable to the clip structure for connecting the top frame to the bottom frame.

In a further non-limiting embodiment of any of the foregoing battery systems, the top frame includes an embossment that includes an opening.

In a further non-limiting embodiment of any of the foregoing battery systems, the bottom frame includes a plurality of ribs that protrude outwardly away from a bottom wall of the bottom frame.

In a further non-limiting embodiment of any of the foregoing battery systems, each rib of the plurality of ribs provides a relatively flat surface for welding a busbar to the cylindrical battery cell.

A traction battery pack according to another exemplary aspect of the present disclosure includes, among other things, an enclosure assembly including an enclosure cover and an enclosure tray, and a battery system housed within the enclosure assembly. The battery system includes a bottom frame, a top frame securable to the bottom frame and including a plurality of compartments, a cylindrical battery cell received within each compartment of the plurality of compartments, a first thermal barrier located between the bottom frame and the enclosure tray, and a second thermal barrier located between the top frame and the enclosure cover.

In a further non-limiting embodiment of the foregoing traction battery pack, a busbar system is located between the first thermal barrier and the bottom frame.

In a further non-limiting embodiment of either of the foregoing traction battery packs, the bottom frame includes a plurality of ribs that protrude outwardly away from a bottom wall of the bottom frame. Each rib of the plurality of ribs provides a surface for welding a busbar of the busbar system to the cylindrical battery cell.

In a further non-limiting embodiment of any of the foregoing traction battery packs, the battery system is configured such that a first cooling channel extends between the cylindrical battery cell and an internal wall of the top frame.

In a further non-limiting embodiment of any of the foregoing traction battery packs, the battery system is configured such that a second cooling channel that is fluidly connected to the first cooling channel extends through the bottom frame.

In a further non-limiting embodiment of any of the foregoing traction battery packs, the battery system is configured such that a third cooling channel that is fluidly connected to the first cooling channel extends through the top frame.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded view of a traction battery pack for an electrified vehicle.

FIG. 3 is a perspective view of the traction battery pack of FIG. 2.

FIG. 4 is a cross-sectional view through section 4-4 of FIG. 3.

FIG. 5 is a top perspective view of a battery module of a battery system.

FIG. 6 is a bottom perspective view of the battery module of FIG. 5.

FIG. 7 is an exploded view of the battery module of FIGS. 5 and 6.

FIG. 8 is a blown-up view of a select portion of the battery module shown in FIG. 6.

FIG. 9 is a cross-sectional view through section 9-9 of FIG. 5.

FIG. 10 is a blown-up view of a select portion of the battery module of FIG. 9.

FIG. 11 illustrates select portions of a top cover of an enclosure frame structure of a battery module.

FIG. 12 illustrates an interface between a bottom frame of an enclosure frame structure and a busbar system.

FIG. 13 schematically illustrates a coolant flow path of an immersion thermal management system of a traction battery pack.

### DETAILED DESCRIPTION

This disclosure details traction battery packs with immersion cooled battery systems. An exemplary traction battery pack battery system may include a battery module that includes a top frame, a bottom frame, and a plurality of cylindrical battery cells. The battery system may be configured to establish an immersion thermal management system that includes various cooling channels for directing an immersion coolant over and around the plurality of cylindrical battery cells. These and other features are discussed in greater detail in the following paragraphs of this detailed description.

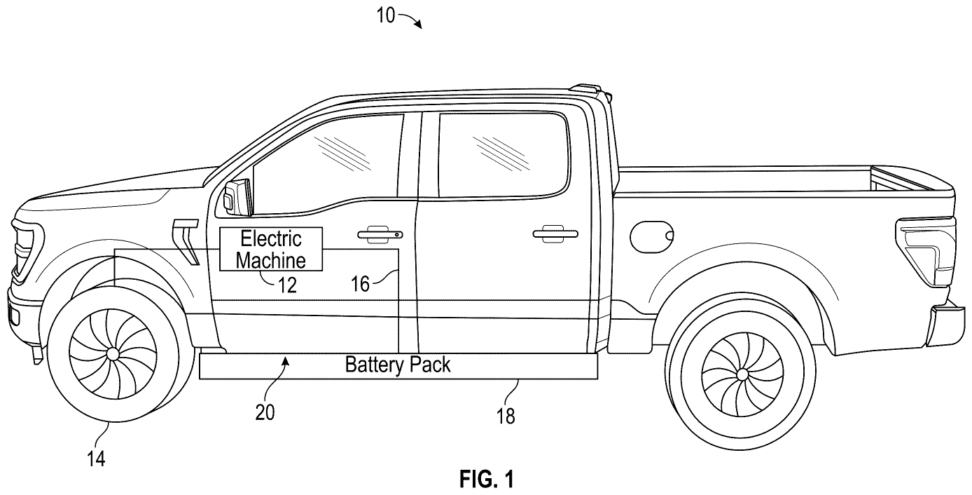

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

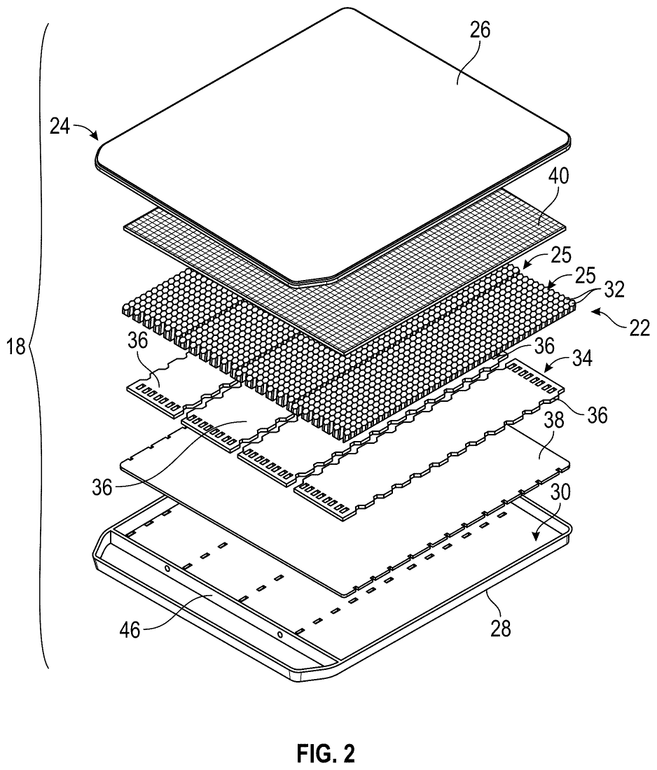

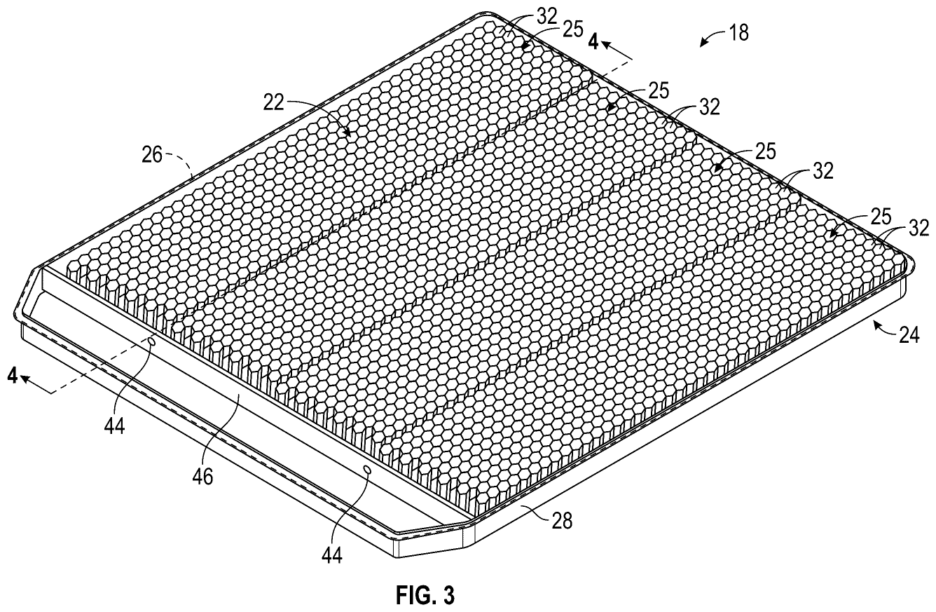

FIGS. 2-4 further illustrate an exemplary design of the traction battery pack 18 of the electrified vehicle 10 of FIG. 1. The traction battery pack 18 may include a battery system 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the battery system 22.

The battery system 22 may include one or more battery modules 25. Each battery module 25 may include a grouping of battery cells 32. Once electrically connected, the battery cells 32 of the battery system 22 may supply electrical power for powering various components of the electrified vehicle 10. The total number of battery cells 32 included as part of the battery system 22 could vary and is therefore not intended to limit this disclosure.

The size of the battery system 22 is scalable to address various manufacturing and packaging requirements of the traction battery pack 18. In an embodiment, the battery system 22 may include two or more individual battery modules 25 that are electrically connected with one another for establishing the battery system 22. In another embodiment, the battery system 22 may include a single, large format battery module, which may be referred to as a cell matrix when the battery system 22 is configured as a structurally integrated type battery system.

The battery cells 32 of each battery module 25 of the battery system 22 may be cylindrical lithium-ion cells. However, battery cells having other geometries and/or other chemistries could alternatively be utilized within the scope of this disclosure. The size of each battery cell 32 could vary depending on the overall design requirements of the traction battery pack 18 and is therefore not intended to limit this disclosure.

A busbar system 34 may electrically connect the battery cells 32 of the battery system 22. The busbar system 34 may include a plurality of busbars 36. The busbar system 34 may be arranged between the battery system 22 and the enclosure tray 28 for locating the busbars 36 at the proper position for securing (e.g., welding) the busbars 36 to the battery cells 32.

A first thermal barrier 38 may be arranged to extend between the busbar system 34 and the enclosure tray 28. The first thermal barrier 38 may include electrically insulative properties for electrically insulating the busbars 36 from the enclosure tray 28 and/or other nearby metallic components.

A second thermal barrier 40 may be arranged to extend between the battery system 22 and the enclosure cover 26. The second thermal barrier 40 may include resiliently flexible or compressible materials for accommodating expansion and/or contraction forces within the traction battery pack 18.

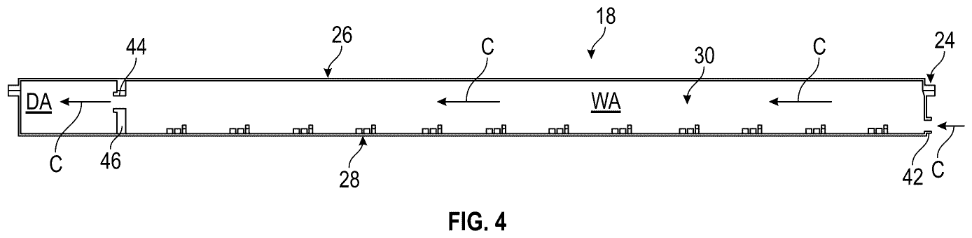

Thermal energy levels of the battery cells 32 of the battery system 22 can increase as the electrified vehicle 10 is operated. A thermal management system can be employed for managing the thermal energy levels of the battery cells 32. The thermal management system may be configured to route a coolant C (see FIG. 4) through the interior area 30 of the traction battery pack 18 in order to manage the thermal energy within the battery module(s) 25 by, for example, using the coolant C to take on heat from the battery cells 32.

In an embodiment, the thermal management system is an immersion thermal management system in which portions of each battery module 25, here at least portions of the battery cells 32 of each battery module 25, for example, can be immersed in the coolant C. Thermal energy can transfer between the coolant C and the battery cells 32 as the coolant C flows over and/or around the battery cells 32. The coolant C can help manage thermal energy levels of the battery cells 32 as well as other components of the battery system 22. The coolant C can also help manage or prevent the spread of thermal energy during certain battery thermal events.

The thermal management system can deliver the coolant C to the interior area 30 through one or more inlets 42. Each inlet 42 may be provided through the enclosure tray 28, for example. The coolant C can then flow through one or more open areas inside the traction battery pack 18 such that the battery cells 32 are immersed in, and directly contacted by, the coolant C. The coolant C can take on thermal energy from the battery cells 32 for managing the thermal energy levels. The coolant C may exit the interior area 30 through one or more outlets 44.

The outlet 44 may be located vertically above the inlet 42. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

Tubing (not shown) may be connected to the outlet 44 for expelling the coolant C from the traction battery pack 18. The coolant C exiting through the traction battery pack 18 can move to a thermal energy exchange device (not shown), such as a heat exchanger, where thermal energy can be transferred from the coolant C to atmosphere. A pump (not shown) can be operated to selectively circulate the coolant C between the traction battery pack 18 and the thermal energy exchange device and then back to the traction battery pack 18.

The coolant C circulated in the immersion thermal management system may be a dielectric fluid or another type of non-conductive fluid (e.g., oil) that is designed for immersion cooling the battery cells 32. However, other non-conductive fluids may also be suitable, and the actual chemical make-up and design characteristics (e.g., dielectric constant, maximum breakdown strength, boiling point, etc.) may vary depending on the environment the traction battery pack 18 is to be employed within.

The outlet 44 of the immersion thermal management system may be provided through a dividing wall 46 of the enclosure tray 28, for example. The dividing wall 46 may subdivide the interior area 30 into a wet area portion WA where the battery system 22 is located and a dry area portion DA. Although not specifically shown, various battery electronic components such as include a bussed electrical center (BEC) and a battery electric control module (BECM), for example, could be positioned within the dry area portion DA.

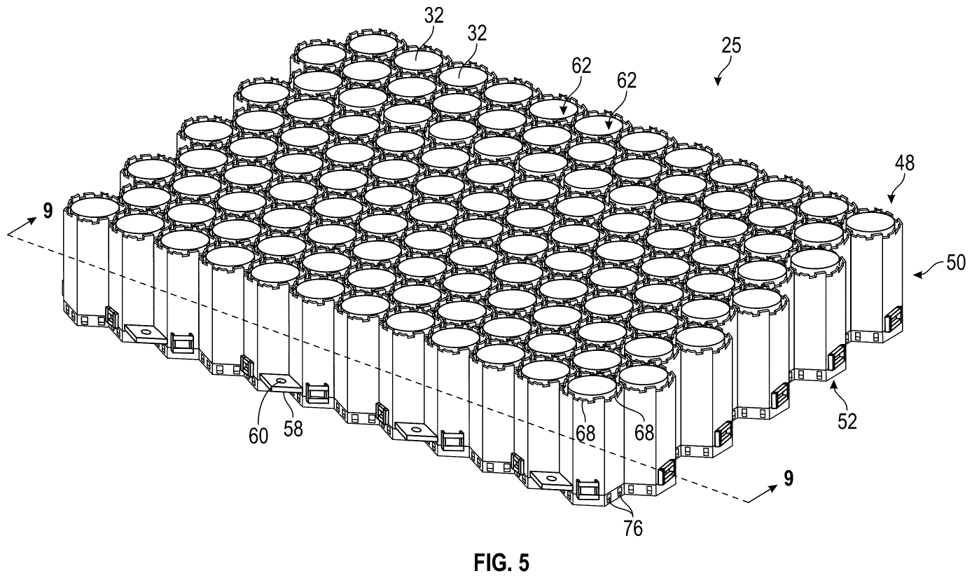

FIGS. 5-11 illustrate aspects associated with an exemplary battery module 25 of the battery system 22 described above. The traction battery pack 18 of the electrified vehicle 10 of FIG. 1 could include one or more battery modules having a design substantially similar to that of the battery module 25 shown in FIGS. 5-8.

The battery cells 32 of the battery module 25 may be packaged together and held within an enclosure frame structure 48. The enclosure frame structure 48 may be a separate structure from the enclosure assembly 24 of the traction battery pack 18. The enclosure frame structure 48 may be made of any suitable plastic material, metallic material, or combinations therefore.

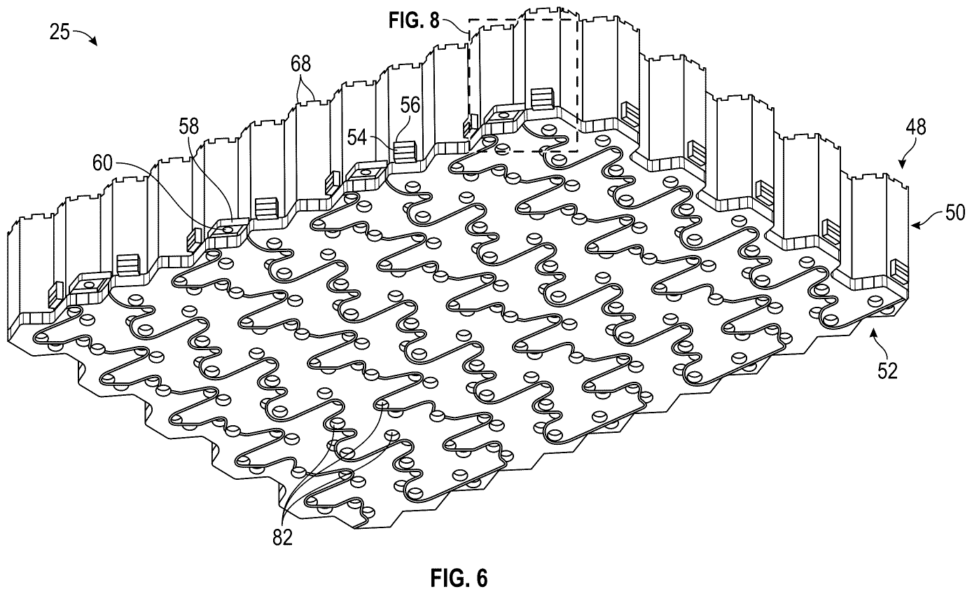

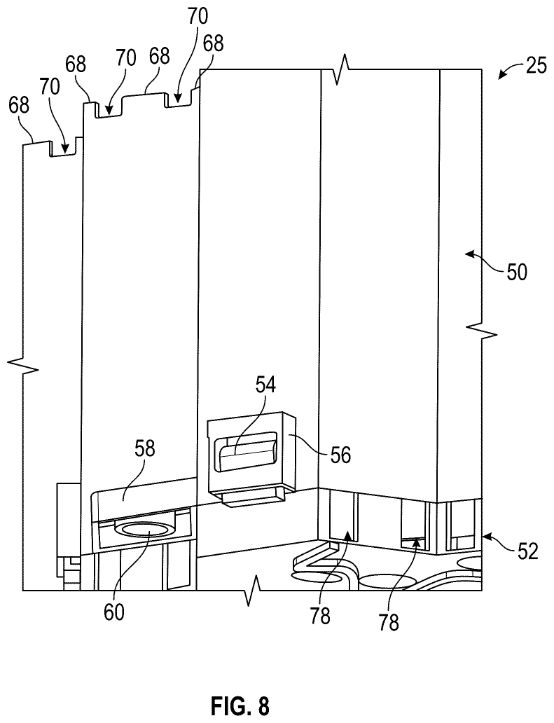

The enclosure frame structure 48 may include a top frame 50 and a bottom frame 52. The top frame 50 may be positioned vertically above the bottom frame 52. The top frame 50 may be clipped or snap-connected to the bottom frame 52 in order to assemble the enclosure frame structure 48 for housing and retaining the battery cells 32. For example, the bottom frame 52 may include a plurality of flexible clips 54 arranged about its outer perimeter. The flexible clips 54 may be adapted to engage a corresponding clip structure 56 provided on the top frame 50 (see, for example, FIGS. 6 and 8). The flexible clips 54 may engage the corresponding clip structures 56 as the top frame 50 is moved into engagement with the bottom frame 52 to physically secure these structures together. Once connected together, the top frame 50 and the bottom frame 52 may substantially surround the battery cells 32. As would be appreciated by a person of ordinary skill in the art having the benefit of this disclosure, an opposite configuration is also contemplated in which the flexible clips 54 are part of the top frame 50 and the clip structures 56 are part of bottom frame 52.

The top frame 50 may additionally include a plurality of embossments 58. Each embossment 58 may include an opening 60 sized for receiving a fastener (e.g., a bolt or screw, not show) for mounting the enclosure frame structure 48 and thus the battery module 25 to the enclosure tray 28.

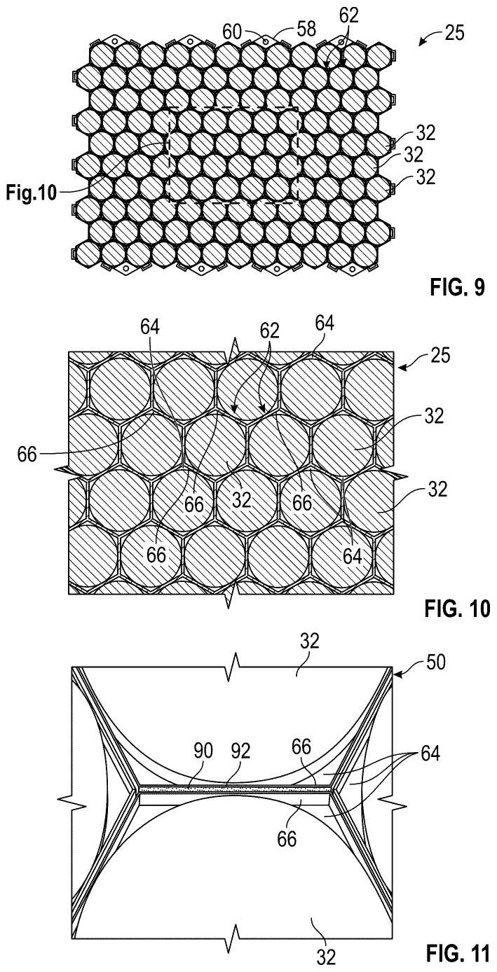

The top frame 50 may include a honeycomb-like structure that provides a plurality of compartments 62 (see FIGS. 9-10) sized for receiving the battery cells 32. For example, each compartment 62 may be hexagonal shaped and may be sized to receive one of the battery cells 32. Each compartment 62 may be established by internal walls 66 of the top frame 50 that are arranged together to circumscribe each compartment 62. However, other configurations are contemplated within the scope of this disclosure.

The space between each battery cell 32 and the internal wall 66 surrounding each compartment 62 may establish a cooling channel 64 (best shown in FIGS. 10-11). The cooling channels 64 are established at least in part due the dichotomy between the respective shapes (e.g., hexagonal and cylindrical, respectively) of the compartments 62 and the battery cells 32. As further discussed below, the coolant C of the immersion thermal management system can flow through the cooling channels 64 in order to immersion cool the battery cells 32.

In some implementations (see FIG. 11, for example), the internal walls 66 of the top frame 50 may include internal cavities 90. A thermal barrier 92 may be provided within each internal cavity 90 for mitigating the conductive heat transfer that can occur between adjacent battery cells 32 of the battery module 25.

The top frame 50 may additionally include a plurality of standoffs 68 (see FIGS. 5, 6, and 8). The standoffs 68 may be located at an uppermost portion of the top frame 50. The standoffs 68 may therefore be located at an opposite side of the top frame 50 from the clip structures 56 and the embossments 58. The standoffs 68 may support the second thermal barrier 40 over top of the battery module 25 in a fully assembled condition of the traction battery pack 18.

The spaces between adjacently located standoffs 68 of the top frame 50 may establish an additional cooling channel 70 (see FIG. 8) for immersion cooling the battery cells 32. The cooling channels 70 may be fluidly connected to the cooling channels 64.

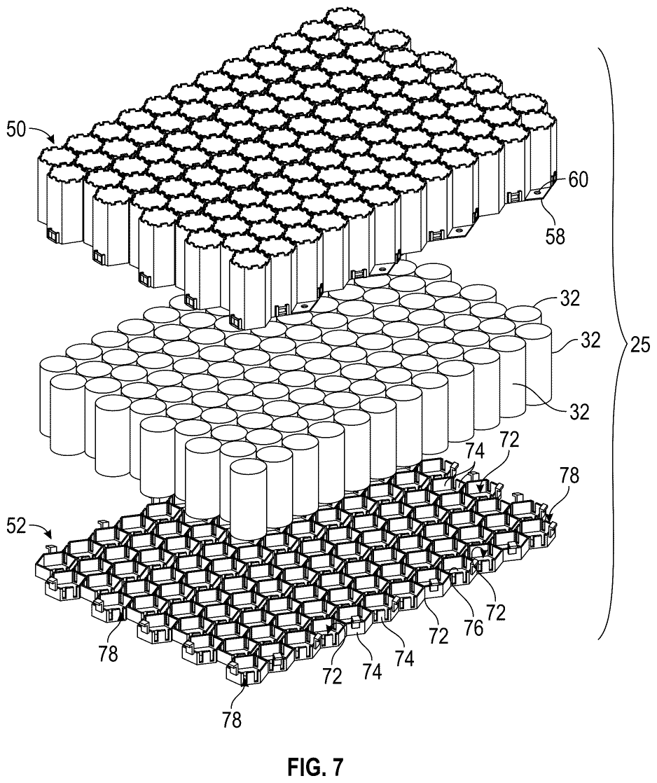

Referring now to FIGS. 5-8, the bottom frame 52 of the enclosure frame structure 48 may include a plurality of pockets 72, with each pocket 72 being sized to receive a bottom portion of one of the battery cells 32 of the battery system 22 (see, e.g., FIG. 7). Each pocket 72 may be established by a set of tabs 74 that protrude upwardly from a floor 76 of the bottom frame 52.

The spaces between adjacently located tabs 74 of the bottom frame 52 may establish additional cooling channels 78 for immersion cooling the battery cells 32. Like the cooling channels 70, the cooling channels 78 may be fluidly connected to the cooling channels 64.

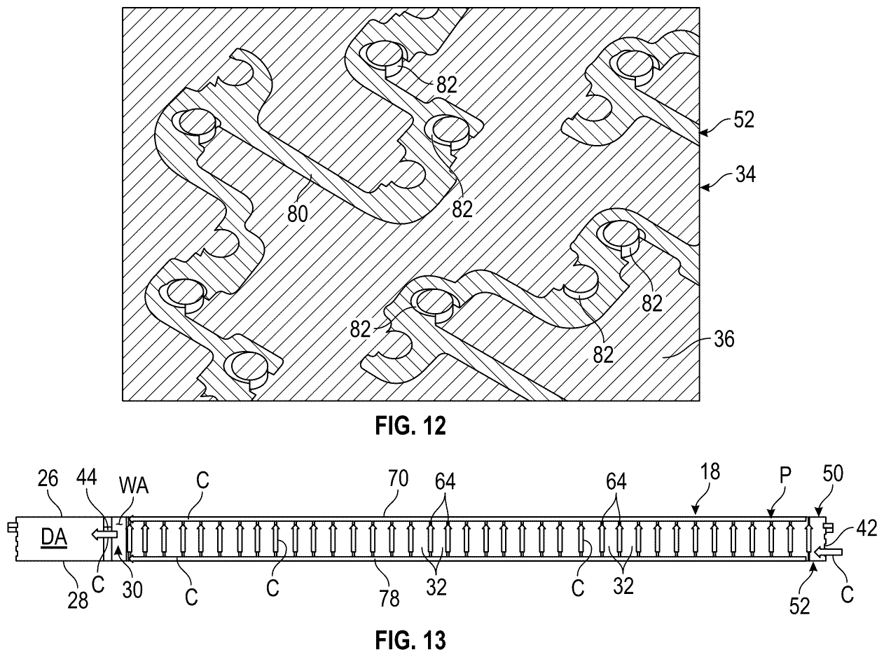

Referring to FIGS. 6 and 12, a plurality of ribs 82 may protrude outwardly away from a bottom wall 80 of the bottom frame 52. The ribs 82 may provide a relatively flat surface to weld against when securing the busbars 36 of the busbar system 34 to the battery cells 32. The ribs 82 may be configured to prevent creepage and maintain a desired clearance distance between the busbars 36.

An exemplary flow path P of the coolant C of the immersion thermal management system described above is schematically illustrated in FIG. 13. The coolant C may enter the traction battery pack 18 through the inlet 42. After entering the interior area 30, the coolant C may enter the cooling channels 78 established by the bottom frame 52 near the bottom side of the battery module 25. The coolant C may then flow upwardly through the cooling channels 64 prior to exiting the cooling channels 64 through the cooling channels 64. The coolant C may then flow downstream toward the outlet 44 upon entering the cooling channels 70. Finally, the coolant C may exit the wet area portion WA of interior area 30 through the outlet 44.

By flowing along the exemplary flow path P, the coolant C can flow over and around the battery cells 32 such that the battery cells 32 are immersed in, and directly contacted by, the coolant C. The coolant C can thus take on thermal energy from the battery cells 32 for managing thermal energy levels during all traction battery pack 18 operating conditions.

The exemplary battery systems of this disclosure include features designed to augment battery cell cooling effect by direct cooling all sides of the cells. The proposed systems are highly scalable and thus facilitate increasing the energy density of the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery system, comprising:
a bottom frame;
a top frame securable to the bottom frame and including a compartment;
a cylindrical battery cell received within the compartment; and
the top frame configured such that a first cooling channel extends between the cylindrical battery cell and an internal wall that establishes at least a portion of the compartment.

2. The battery system as recited in claim 1, wherein the compartment is hexagonal shaped.

3. The battery system as recited in claim 2, wherein the top frame includes a honeycomb-like structure that provides the compartment.

4. The battery system as recited in claim 1, wherein an upper portion of the top frame includes a first standoff and a second standoff.

5. The battery system as recited in claim 4, wherein a second cooling channel extends between the first standoff and the second standoff.

6. The battery system as recited in claim 5, wherein the second cooling channel is fluidly connected to the first cooling channel.

7. The battery system as recited in claim 1, wherein the bottom frame includes a pocket sized to receive the cylindrical battery cell.

8. The battery system as recited in claim 7, wherein the pocket is established by a set of tabs that protrude upwardly from a floor of the bottom frame.

9. The battery system as recited in claim 8, wherein a second cooling channel extends between a first tab and a second tab of he set of tabs.

10. The battery system as recited in claim 9, wherein the second cooling channel is fluidly connected to the first cooling channel.

11. The battery system as recited in claim 1, wherein the bottom frame includes one of a flexible clip or a clip structure and the top frame includes the other of the flexible clip or the clip structure, and further wherein the flexible clip is engageable to the clip structure for connecting the top frame to the bottom frame.

12. The battery system as recited in claim 1, wherein the top frame includes an embossment that includes an opening.

13. The battery system as recited in claim 1, wherein the bottom frame includes a plurality of ribs that protrude outwardly away from a bottom wall of the bottom frame.

14. The battery system as recited in claim 13, wherein each rib of the plurality of ribs provides a relatively flat surface for welding a busbar to the cylindrical battery cell.

15. A battery pack, comprising:
an enclosure assembly including an enclosure cover and an enclosure tray; and
a battery system housed within the enclosure assembly, wherein the battery system includes:
a bottom frame;
a top frame securable to the bottom frame and including a plurality of compartments;
a cylindrical battery cell received within each compartment of the plurality of compartments;
a first thermal barrier located between the bottom frame and the enclosure tray; and
a second thermal barrier located between the top frame and the enclosure cover.

16. The battery pack as recited in claim 15, comprising a busbar system located between the first thermal barrier and the bottom frame.

17. The battery pack as recited in claim 16, wherein the bottom frame includes a plurality of ribs that protrude outwardly away from a bottom wall of the bottom frame, and further wherein each rib of the plurality of ribs provides a surface for welding a busbar of the busbar system to the cylindrical battery cell.

18. The battery pack as recited in claim 15, wherein the battery system is configured such that a first cooling channel extends between the cylindrical battery cell and an internal wall of the top frame.

19. The battery pack as recited in claim 18, wherein the battery system is configured such that a second cooling channel that is fluidly connected to the first cooling channel extends through the bottom frame.

20. The battery pack as recited in claim 19, wherein the battery system is configured such that a third cooling channel that is fluidly connected to the first cooling channel extends through the top frame.
